(19) United States
(12) Patent Application Publication
(10) Pub. No.: US 2024/0248896 A1
(43) Pub. Date: Jul. 25, 2024

(54) SCHEMA-AWARE ENCODING OF NATURAL LANGUAGE

(71) Applicant: Microsoft Technology Licensing, LLC, Redmond, WA (US)

(72) Inventors: Uros BOSKOVIC, Belgrade (RS); Neda Pistinjat NIKOLIC, Belgrade (RS); Ivan VUJIC, Belgrade (RS); Atabak ASHFAQ, Redmond, WA (US); Filip CAREVIC, Cacak (RS)

(21) Appl. No.: 18/157,557

(22) Filed: Jan. 20, 2023

(51) Int. Cl. G06F 16/2452

(52) U.S. Cl. CPC G06F 16/24522

(57) ABSTRACT

Methods, systems and computer program products are provided for performing schema-aware encoding of natural language (NL). NL may be encoded into a schema-aware encodings to improve (e.g., SQL) queries generated by (e.g., SQL) database query generators from the NL. Improved queries may improve the accuracy of query execution results generated by a (e.g., SQL) database server, which may reduce resource consumption and improve customer satisfaction by avoiding repetitious searches. Encoded NL may include the NL and/or an indication of the task (e.g., convert encoded NL into an SQL query) along with a DB schema. A DB schema may include full or partial lists of DB table names, DB column names, and interrelationships between DB entities, such as foreign key relationships between tables. NL may be encoded (e.g., in an order) optimized for a type of NL model, e.g., a text to SQL autoregressive language model.

### BACKGROUND

Inferior SQL queries result in inferior search results, potentially inappropriate conclusions based on the inferior results, dissatisfied customers, and/or unnecessary consumption of resources with repetitive searches in pursuit of the desired query and results. Models that support conversion of natural language text to structured query language (SQL) may contribute to these problems by, for example, generating non-SQL syntax in SQL queries and/or by generating SQL queries without context.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for performing schema-aware encoding of natural language. A natural language (NL) question may be encoded into a schema-aware encoded question, for example, to improve a query (e.g., structured query language (SQL) query) generated by a database query generator (e.g., an SQL code generator model) based on the question. An improved query may improve the accuracy of results generated by a database server (e.g., SQL database server) based on query execution, which may reduce resource consumption and improve customer satisfaction, e.g., by avoiding repetitious searches for desired results. An encoded NL question may include, for example, the NL question and/or an indication of the task (e.g., to convert the encoded NL question into an SQL query) along with a DB schema. A schema may include, for example, one or more full or partial lists of DB tables names, DB column names, and interrelationships between DB entities (e.g., tables), such as primary key-foreign key relationships between tables. NL encoding may be optimized for a type of NL processing model, e.g., an autoregressive language model used to generate a SQL query. An NL question may be encoded with a relative ordering of schema (e.g., table names, column names, foreign key relationships), the NL question, and/or the task.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 illustrates a block diagram of an example computing environment for schema-aware encoding of natural language, according to an embodiment.

FIG. 2 illustrates an example of database schema information, according to an embodiment.

FIG. 3 illustrates an example of a workflow for schema-aware encoding of natural language, according to an embodiment.

FIG. 4 illustrates an example of a schema aware encoder, according to an embodiment.

FIG. 5 illustrates a flowchart of an example method for performing schema-aware encoding of natural language, according to an example embodiment.

FIG. 6 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

As noted in the Background Section, above, inferior SQL queries result in inferior search results, potentially inappropriate conclusions based on the inferior results, dissatisfied customers, and/or unnecessary consumption of resources with repetitive searches in pursuit of the desired query and results. Models that support conversion of natural language text to structured query language (SQL) may contribute to these problems by, for example, generating non-SQL syntax in SQL queries and/or by generating SQL queries without context.

Methods, systems and computer program products are provided for performing schema-aware encoding of natural language. A natural language (NL) question may be encoded into a schema-aware encoded question, for example, to improve a query (e.g., structured query language (SQL) query) generated by a database query generator (e.g., an SQL code generator model) based on the question. An improved query may improve the accuracy of results generated by a database server (e.g., SQL database server) based on query execution, which may reduce resource consumption and improve customer satisfaction, e.g., by avoiding repetitious searches for desired results. An encoded NL question may include, for example, the NL question and/or an indication of the task (e.g., to convert the encoded NL question into an SQL query) along with a DB schema. A schema may include, for example, one or more full or partial lists of DB tables names, DB column names, and interrelationships between DB entities (e.g., tables), such as primary key-foreign key relationships between tables. NL encoding may be optimized for a type of NL processing model, e.g., an autoregressive language model used to generate a SQL query. An NL question may be encoded with a relative ordering of schema (e.g., table names, column names, foreign key relationships), the NL question, and/or the task.

Natural language (e.g., text) to SQL (Text2SQL) may be used to convert a natural language prompt (e.g., a question) to an SQL query that may be used to search an SQL database. A Text2SQL model may be taught (e.g., trained) how to generate an SQL query corresponding to the input question. A Text2SQL model may (e.g., efficiently) generate an SQL query, for example, if the model is provided with detailed information about the targeted database and natural language question.

A lack of context may lead to poor performance generating complex queries. A model unaware of database schema may struggle to infer potential JOINs among tables. A model unaware of the task may generate non-SQL syntax. Inputs (e.g., NL questions) may be parsed and processed to generate encoded NL that provides context, such as a database schema.

A schema-aware input encoding may be optimized for various types of models and/or databases, such as autoregressive language models and/or complex SQL databases. Optimization of input encodings may provide a model with details to generate accurate SQL queries for intended databases. A schema-aware input encoding may be used, for example, in combination with a generative pre-trained transformer (GPT) model, such as a third generation GPT model (GPT-3 model) to generate an SQL query from an underlying NL input. A model (e.g., an autoregressive language model) may be trained (e.g., fine-tuned) and tested on schema-aware encoded input. Model training and testing may be performed, for example, using a large-scale human-labeled dataset (e.g., a Spider dev dataset).

Text2SQL conversion may be implemented as a sequence-to-sequence task, e.g., a translation task. Natural language may be translated to SQL code, e.g., for use with large language models. Language models may exhibit a (e.g., substantial) meta-learning ability, e.g., a capability of a model to grasp diverse skill sets and/or to learn to recognize patterns during unsupervised pre-training. Inputs may be designed/configured to utilize a meta-learning capability.

Encoded NL may implicitly or explicitly indicate a task to a model, such as an indication that the model should generate (e.g., only) SQL code. A task instruction may be in a variety of forms, such as one or more characters at the end of an input encoding.

An input encoding may indicate a database schema, such as table names of a targeted database, column names of a targeted database, column types, primary keys format, interrelationships between database entities (e.g., tables), etc. A database schema encoding may account (e.g., vary) for queries, which may have various complexity, such as simple queries targeting a (e.g., only one) table (e.g., queries without a JOIN clause) versus complex queries targeting complex multi-table environments.

An interrelationship may indicate, for example, information about foreign key relationships between database entities (e.g., tables in a database). An NL encoding may include information indicating whether some parts of the natural language partially/fully align with the existing table and column names. An encoding may become too complex, in which case a model may struggle to infer which parts of the encoded input it should attend to during the processing of a the encoded NL (e.g., for database query generation).

An NL encoding may provide database schema relationship information while maintaining simplicity for improved model performance. For example, an encoding may exploit a meta-learning ability of big language models in a zero-shot environment.

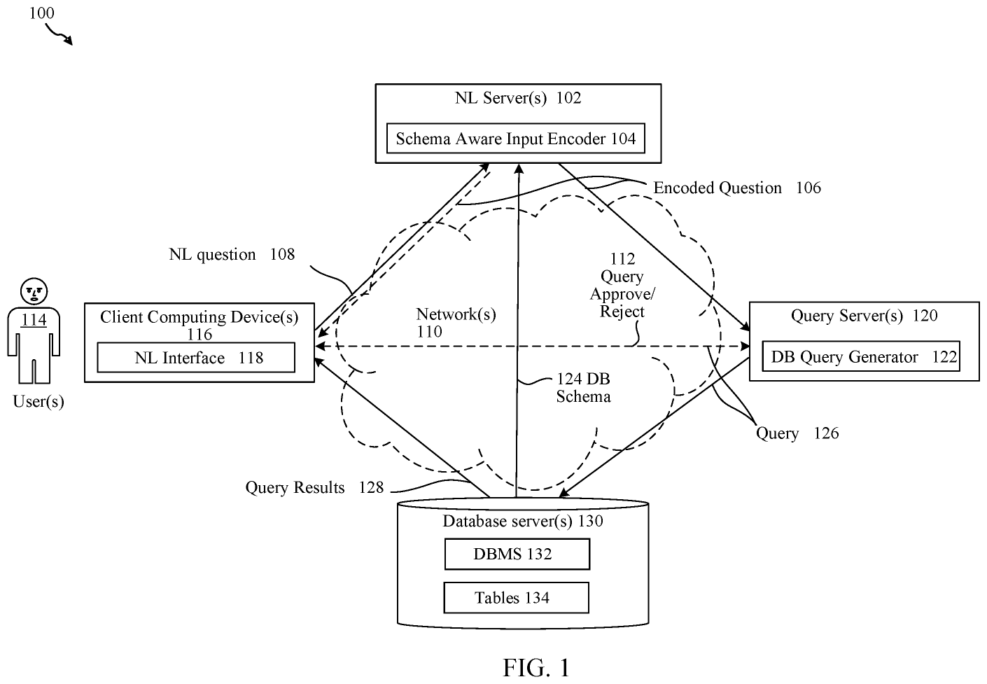

Embodiments may be implemented in a variety of systems/environments. For example, FIG. 1 illustrates a block diagram of an example computing environment 100 for schema-aware encoding of natural language, according to an embodiment. Other examples schema-aware encoding of natural language may be implemented.

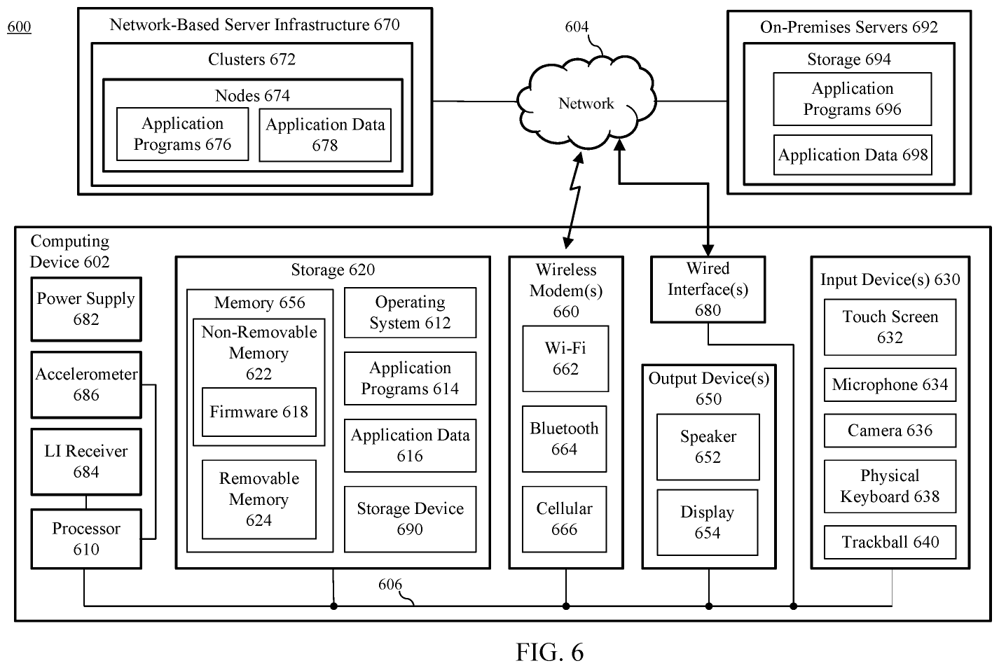

As shown in FIG. 1, computing environment 100 includes NL server(s) 102, client computing device(s) 116, query server(s) 120, and database server(s) 130, which may be communicatively coupled by network(s) 110. A computing environment may be any computing environment (e.g., any combination of hardware, software, and firmware) configured over any area. An example computing device with example features is presented in FIG. 6. Example computing environment 100 presents one of many possible examples of computing environments. Example computing environment 100 may comprise any number of computing devices and/or servers, such as example components illustrated in FIG. 1 and other additional or alternative devices not expressly illustrated.

Network(s) 110 may include, for example, one or more of any of a local area network (LAN), a wide area network (WAN), a personal area network (PAN), a combination of communication networks, such as the Internet, and/or a virtual network. In example implementations, NL server(s) 102, client computing device(s) 116, query server(s) 120, and database server(s) 130 may be communicatively coupled via network(s) 110. In an implementation, any one or more of NL server(s) 102, client computing device(s) 116, query server(s) 120, and database server(s) 130 may communicate via one or more application programming interfaces (APIs), and/or according to other interfaces and/or techniques. NL server(s) 102, client computing device(s) 116, query server(s) 120, and database server(s) 130 may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

Client computing device(s) 116 may comprise computing devices utilized by one or more users (e.g., individual users, family users, enterprise users, governmental users, administrators, hackers, etc.) generally referenced as user(s) 114. Client computing device(s) 116 may comprise one or more applications, operating systems, virtual machines (VMs), storage devices, etc., that may be executed, hosted, and/or stored therein or via one or more other computing devices via network(s) 110. In an example, client computing device(s) 116 may access one or more server devices, such as NL server(s) 102, query server(s) 120, and/or database server(s) 130, to provide information, request one or more services (e.g., NL question encoding, conversion to queries, query execution) and/or receive one or more results (e.g., query results 128). Client computing device(s) 116 may represent any number of computing devices and any number and type of groups (e.g., various users among multiple cloud service tenants). User(s) 114 may represent any number of persons authorized to access one or more computing resources. Client computing device(s) 116 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Client computing device(s) 116 are not limited to physical machines, but may include other types of machines or nodes, such as a virtual machine, that are executed in physical machines. Client computing device(s) 116 may each interface with NL server(s) 102, query server(s) 120, and database server(s) 130, for example, through APIs and/or by other mechanisms. Any number of program interfaces may coexist on client computing device(s) 116. An example computing device with example features is presented in FIG. 6.

Each of client computing device(s) 116 may have a respective computing environment. Client computing device(s) 116 may execute one or more processes in their respective computing environments. A process is any type of executable (e.g., binary, program, application) that is being executed by a computing device. A computing environment may be any computing environment (e.g., any combination of hardware, software and firmware). For example, client computing device(s) 116 may execute NL interface 118, which may provide a user interface (e.g., a graphical user interface (GUI)) for user(s) 114 to interact with, such as to enter, review and edit NL questions 108, receive, access, review, edit, and/or submit encoded question 106, receive, review, edit, and/or submit query 126, receive, access, review, edit, and/or otherwise utilize query results 128, and so on. NL interface 118 may be configured to communicate (e.g., via network(s) 110) with one or more applications executed by NL server(s) (e.g., schema aware input encoder 104), query server(s) 120 (e.g., DB query generator 122), database server(s) 130 (e.g., database management system (DBMS) 132), and so on.

User(s) 114 may interact with NL interface 118, for example, to create and manage database queries. For example, user(s) 114 may use NL interface 118 to develop and/or to submit prospective database queries. User(s) 114 may enter database queries in natural language (NL), e.g., NL question 108. NL interface 118 may be configured to send/transmit NL question 108 to NL server(s) 102 for pre-execution processing (e.g., encoding or translation) and/or analysis. NL question 108 may include information, such as information about client computing device(s) 116, user(s) 114, default and/or custom settings/preferences (e.g., whether to return encoded question 106 and/or query 126, whether to proceed with or without approval by user(s) 114, and so on). NL question 108 may be encoded into encoded question 106 by NL server(s) 102. NL server(s) 102 may be configured to return encoded question 106 to client computing device(s) 116, e.g., based on a setting in NL interface 118 selected by user(s) 114. NL server(s) 102 may be configured to send encoded question 106 to query server(s) 120, for example, without approval by user(s) 114 or with approval by user(s) 114, e.g., based on a setting in NL interface 118 selected by user(s) 114.

Encoded question 106 may be converted or translated into query 126 by query server(s) 120. Query server(s) 120 may generate query 126 in a Structured Query Language SQL) or SQL-like dialect (e.g., SCOPE), which may use, for example, the C #programming language and/or user-defined functions (UDFs). Query server(s) 120 may be configured to return query 126 to client computing device(s) 116, e.g., based on a setting in NL interface 118 selected by user(s) 114. User(s) 114 may review query 126 and indicate 112 whether they approve or reject query 126 for submission to database server(s) 130. Query server(s) 120 may be configured to send, or not send, query 126 to database server(s) 130, for example, based on indication 112 provided by user(s) 114.

Client computing device(s) 116 may receive query results 128 from database server(s) 130. Database server(s) 130 may execute query 126 against a database (e.g., tables 134). Database server(s) 130 may generate and return query results 128 (e.g., one or more row and/or columns of a table or other data set) to client computing device(s) 116. User(s) 114 may interact with NL interface 118 to access query results 128. User(s) 114 may use NL interface 118 to view and/or edit query results 128.

NL server(s) 102 may comprise one or more computing devices, servers, services, local processes, remote machines, web services, etc. associated with processing NL questions (e.g., NL question 108). In an example, NL server(s) 102 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for processing NL questions. NL server(s) 102 may be implemented as a plurality of programs executed by one or more computing devices.

NL server(s) 102 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. NL server(s) 102 are not limited to physical machines, but may include other types of machines or nodes, such as a virtual machine, that are executed in physical machines.

NL server(s) 102 may interface with client computing device(s) 116, query server(s) 120, and database server(s) 130, for example, through APIs and/or by other mechanisms. Any number of program interfaces may coexist on NL server(s) 102. An example computing device with example features is presented in FIG. 6. NL server(s) 102 may comprise one or more applications, operating systems, virtual machines (VMs), storage devices, etc., that may be executed, hosted, and/or stored therein or via one or more other computing devices via network(s) 110. In an example, NL server(s) 102 may communicate with one or more computing devices, such as with client computing device(s) 116 to receive information (e.g., NL question 108) and/or provide information (e.g., encoded question 106), and with query server(s) 120 to receive and/or provide information (e.g., encoded question 106). In some examples, NL server(s) 102 may be combined with query server(s) 120 and/or database server(s) 130.

NL server(s) 102 may execute schema aware input encoder 104. Schema aware input encoder 104 may be configured to communicate (e.g., via network(s) 110) with one or more applications executed by client computing device(s) 116 (e.g., NL interface 118), query server(s) 120 (e.g., DB query generator 122), database server(s) 130 (e.g., DBMS 132), and so on. Schema aware input encoder 104 may receive DB schema 124, e.g., from DBMS 132. Schema aware input encoder 104 may receive NL question 108. Schema aware input encoder 104 may (re)configure and/or otherwise account for the (e.g., particular) database(s) indicated in NL question 108, e.g., according to schema information about one or more databases indicated by DB schema 124. Schema aware input encoder 104 may generate encoded question 106, e.g., based on the one or more databases indicated by NL question 108 and schema information in DB schema 124. Schema aware input encoder 104 may send encoded question 106 to query server(s) 120 and client computing device(s) 116, e.g., depending on default or custom settings indicated by NL interface 118 in NL question 108 or other communication. NL server(s) 102 may determine whether and/or when to send encoded question 106 to query server(s) 120, such as based on an implied or express indication by NL interface 118 to submit encoded question 106 to query server(s) 120.

Query server(s) 120 may comprise one or more computing devices, servers, services, local processes, remote machines, web services, etc. associated with processing encoded NL questions (e.g., encoded question 106). In an example, query server(s) 120 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for processing NL questions. Query server(s) 120 may be implemented as a plurality of programs executed by one or more computing devices.

Query server(s) 120 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Query server(s) 120 are not limited to physical machines, but may include other types of machines or nodes, such as a virtual machine, that are executed in physical machines.

Query server(s) 120 may interface with client computing device(s) 116, NL server(s) 102, and database server(s) 130, for example, through APIs and/or by other mechanisms. Any number of program interfaces may coexist on query server(s) 120. An example computing device with example features is presented in FIG. 6. Query server(s) 120 may comprise one or more applications, operating systems, virtual machines (VMs), storage devices, etc., that may be executed, hosted, and/or stored therein or via one or more other computing devices via network(s) 110. In an example, query server(s) 120 may communicate with one or more computing devices, such as with client computing device(s) 116 to provide information (e.g., query 126) and/or receive information (e.g., query approve/reject indication 112), with NL server(s) 102 to receive and/or provide information (e.g., encoded question 106), and with database server(s) 130 (e.g., DBMS 132) to receive and/or provide information (e.g., query 126). In some examples, query server(s) 120 may be combined with NL server(s) 102 and/or database server(s) 130.

Query server(s) 120 may execute DB query generator 122. DB query generator 122 may be configured to communicate (e.g., via network(s) 110) with one or more applications executed by client computing device(s) 116 (e.g., NL interface 118), NL server(s) 102 (e.g., schema aware input encoder 104), database server(s) 130 (e.g., DBMS 132), and so on. DB query generator 122 may receive encoded question 106, generate query 126, receive query reject/approve indication 112, and send query 126 to database server(s) 130 and client computing device(s) 116, e.g., depending on default or custom settings indicated by NL interface 118 in NL question 108 or other communication.

Database server(s) 130 may comprise one or more computing devices, servers, services, local processes, remote machines, web services, etc. associated with processing queries (e.g., query 126) against one or more databases. In an example, database server(s) 130 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for processing NL questions. Database server(s) 130 may be implemented as a plurality of programs executed by one or more computing devices.

Database server(s) 130 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. NL server(s) 102 are not limited to physical machines, but may include other types of machines or nodes, such as a virtual machine, that are executed in physical machines.

Database server(s) 130 may interface with client computing device(s) 116, NL server(s) 102, and query server(s) 120, for example, through APIs and/or by other mechanisms. Any number of program interfaces may coexist on database server(s) 130. An example server computing device with example features is presented in FIG. 6. Database server(s) 130 may comprise one or more applications, operating systems, virtual machines (VMs), storage devices, etc., that may be executed, hosted, and/or stored therein or via one or more other computing devices via network(s) 110. In an example, database server(s) 130 may communicate with one or more computing devices, such as with client computing device(s) 116 to provide information (e.g., query results 128) and/or receive information, with NL server(s) 102 to receive and/or provide information (e.g., DB schema 124), and with database server(s) 130 to provide and/or receive information (e.g., query 126). In some examples, database server(s) 130 may be combined with NL server(s) 102 and/or query server(s) 120.

Database server(s) 130 may execute DBMS 132. DBMS 132 may be configured to communicate (e.g., via network(s) 110) with one or more applications executed by client computing device(s) 116 (e.g., NL interface 118), NL server(s) 102 (e.g., schema aware input encoder 104), query server(s) 120 (e.g., DB query generator 122), and so on. DBMS 132 may manage tables 134 among one or more databases, provide DB schema 124 to schema aware input encoder 104, receive, schedule, and execute query 126, execute query 126 against tables 134, and send query results 128 to client computing device(s) 116, e.g., depending on default or custom settings indicated by NL interface 118 in NL question 108 or other communication.

One or more processes implemented by client computing device(s) 116, query server(s) 120 and/or database server(s) 130 natural language (NL) question may be improved by encoding NL question 108 into a schema-aware encoded question. Improving the encoding of NL question 108 (e.g., in the form of encoded question 106), and, therefore, query 126 may improve the accuracy of results generated by database server 130 (e.g., SQL database server) based on query execution, which may reduce resource consumption and improve customer satisfaction, e.g., by avoiding repetitious searches for desired results. For example, query (e.g., structured query language (SQL) query) 126 generated by a database query generator 122 (e.g., based on an SQL code generator model) may more accurately reflect NL question 108 relative to tables 134, make execution of query 126 by DBMS 132 more efficient, and/or reduce duplicative NL questions, question encoding, query generation, and query execution in search of accurate query results.

Encoded NL question 106 may include, for example, NL question 108 and/or an indication of the task (e.g., to convert encoded NL question 108 into an SQL query) along with information associated with DB schema 124. Schema information included in encoded question 106 may include, for example, one or more full or partial lists of DB tables names for tables 134, DB column names for tables 134, and interrelationships between DB entities (e.g., tables 134), such as foreign key relationships between tables 134. NL encoding may be optimized for a type of NL processing model, e.g., an autoregressive language model used to generate a SQL query. NL question 108 may be encoded into encoded question 106 with a relative ordering of schema (e.g., table names, column names, foreign key relationships), NL question 108, and/or the task.

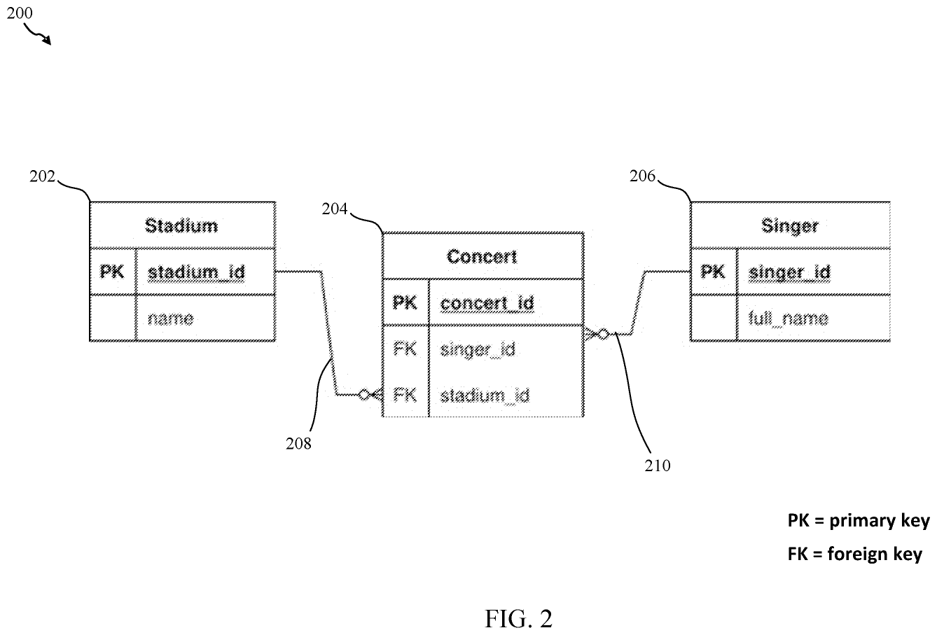

FIG. 2 illustrates an example 200 of database schema information, according to an embodiment. As shown in FIG. 2, example 200 shows three database entities (e.g., tables). The tables shown in example 200 may represent an example of a few tables among many tables 134. Three tables are shown in example 200. The tables may represent information about concerts, which may take place at a venue (e.g., stadium) with one or more singers. Example 200 visualizes information that may be included in DB schema 124. Database schema information may include table names. Table names include stadium 202, concert 204, and singer 204. The primary key identifier (ID) for stadium table 202 is “stadium_id.” The primary key identifier (ID) for concert table 204 is “concert_id.” The primary key identifier (ID) for singer table 206 is “singer_id.”

Example 200 shows relationships between database entities (e.g., tables). The relationship between tables shown in example 200 is primary key (PK) to foreign key (FK) relationships. For example, stadium table 202 and concert table 204 have PK-FK relationship 208. Singer table 206 and concert table 204 have PK-FK relationship 210.

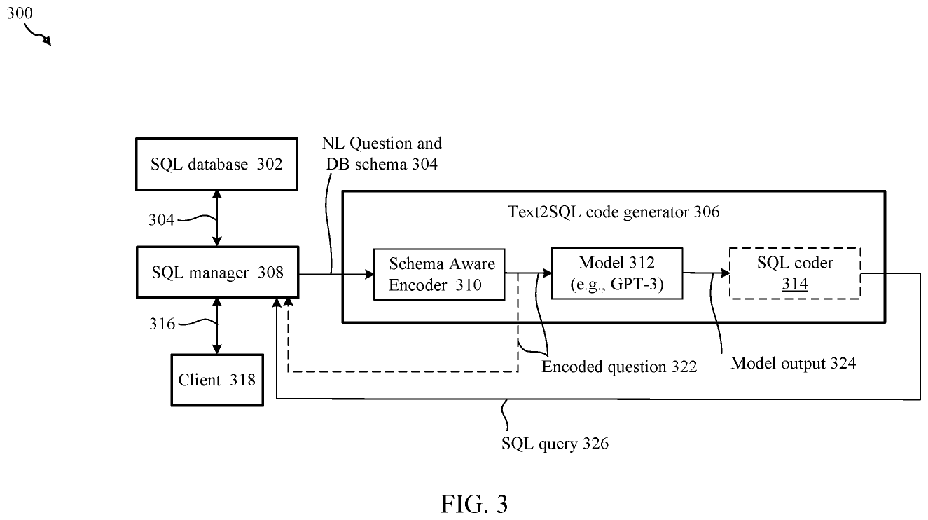

FIG. 3 illustrates an example 300 of a workflow for schema-aware encoding of natural language, according to an embodiment. Workflow example 300 may be implemented in a wide variety of computing environments, including the example computing environment shown in FIG. 1. As shown in FIG. 3, example 300 shows a workflow from an NL question to query results among workflow participants, including client 318, SQL manager 308, SQL database 302, and text to SQL (Text2SQL) code generator 306.

Client 318 may receive a database query in natural language (NL) from a user. Client 318 may send the query as an NL question in client-manager communications 316 to SQL manager 308 for handling. The NL question may include information, such as information about client 318, user(s), default and/or custom settings/preferences (e.g., whether to return an encoded question and/or query based on the NL question, whether to proceed with an encoded question and/or query with or without approval by user(s), and so on). Client 318 may be an agent of SQL manager 308.

SQL manager 308 may receive the NL question from client 318 in client-manager communications 316. SQL manager 308 may receive database schema information 304 from SQL database 302. SQL manager 308 may request database schema information for one or more database management systems, for example, based on one or more triggers/events, such as periodic time and/or receipt of a client request.

SQL manager 308 may provide to Text2SQL code generator 306 the NL question and DB schema information 304. SQL manager 308 may provide the NL question and DB schema information 304 at the same or different times. For example, SQL manager 308 may selectively provide or pair relevant database schema information with the NL question in client-manager communications 316 depending on the database(s) pertinent to the NL question. In some examples, SQL manager 308 may provide schema information about one or more databases to Text2SQL code generator 306 separate from providing NL question information.

Text2SQL code generator 306 may receive the NL question and DB schema information 304, generate and return SQL query 326 to SQL manager 308. Text2SQL code generator 306 may comprise, for example, schema aware encoder 310 and model 312 (e.g., and in some implementations SQL coder 314).

Schema aware encoder 310 may receive the NL question and DB schema information 304. Schema aware encoder 310 may implement input encoding grammar configured to provide model 312 with information pertaining to query generation tasks performed by model 312, such as database context and the natural language question posed for one or more databases. Schema aware encoder 310 may exploit a meta-learning capability of a big language auto-regressive model, e.g., in a zero-shot environment.

Schema aware encoder 310 encoding grammar may include an indication of the (e.g., specific) format of database schema relationships, for example, to aid model 312 in understanding one or more types of database relationships, such as foreign key relationships, which may improve the performance of model 312, such as by improving the generation of appropriate JOIN clauses for SQL coding of the NL question.

Schema aware encoder 310 encoding grammar may include a separator and/or a task description, which may take advantage of a meta-learning capability of model 312. Model 312 may attempt to generate non-SQL syntax without an instruction or other indication that the task is to generate SQL syntax. A task indication may avoid a need for post-processing, such as complex output parsing software to interpret model output.

Schema aware encoder 310 encoding grammar may include an ordering (e.g., a fixed ordering) of encoding components. Encoding output (e.g., encoded question 322) may be optimized, for example, for use with decoder-only model architectures, where the order of input tokens may be important. For example, an order of encoded question components may include a list of table and column names in SQL database 302, a list of encoded schema relationships in SQL database 302, the NL question, a separator and a task description.

In some examples, encoded question 322 may be provided to SQL manager 308, which may provide encoded question 322 to client 318, for example, based on an indication by client 318. For example, client 318 may permit a user to review and approve or reject encoded question 322. A user may indicate to client 318 and/or SQL manager 308 whether to proceed or halt the process by Text2SQL code generator 306. For example, encoded question 322 may be human readable. Reviewing encoded question 322 may assist users with understanding how to draft NL questions based on how their NL questions are processed, e.g., converted into encoded questions, SQL queries and query results, thereby reducing resource consumption by reducing repetitive searches in an effort to blindly improve the accuracy of searching and search results.

Model 312 may generate model output 324 based on encoded question 322. Model output 324 may include a prediction of an SQL query (e.g., SQL query 326 or a precursor to SQL query 326). The prediction may include or may be associated with a probability or confidence in the predicted SQL query. In some examples, model 312 may be a neural network (NN) machine-learning (ML) model. Model 312 may be trained to use internet data to generate text. Model 312 may be, for example, an autoregressive language model, such as a generative pre-trained transformer (GPT) model (e.g., a third generation GPT (GPT-3) model). In some examples, model output 324 may be SQL query 326 (e.g., providing a complete conversion or translation of the encoded question into an SQL query).

In some examples, SQL coder 314 may complete the conversion or translation of the encoded question into SQL query 326. SQL coder 314 may generate SQL query 326 based on model output 324. Improved accuracy in model output 324 may improve the accuracy of SQL coder 314 in generating SQL query 326.

SQL query 326 may be returned to SQL manager 308, which may provide (e.g., or provide access to) SQL query 326 to client 318, for example, based on an indication by client 318. For example, client 318 may display SQL query 326 to a user to enable the user to review and approve or reject SQL query 326. A user may indicate to client 318 and/or SQL manager 308 whether to proceed with query execution. Reviewing SQL query 326 may assist users with understanding how to draft NL questions based on how their NL questions are processed, e.g., converted into SQL queries and query results, thereby reducing resource consumption by reducing repetitive searches in an effort to blindly improve the accuracy of searching and search results.

SQL manager 308 may (e.g., with user approval indicated by client 318) schedule and execute SQL query 326 against SQL database 302. SQL database 302 may return query results to SQL manager 308, which may return the results to client 318. A user may use client 318 to review and/or utilize query results, such as by executing a program to display and/or process query results.

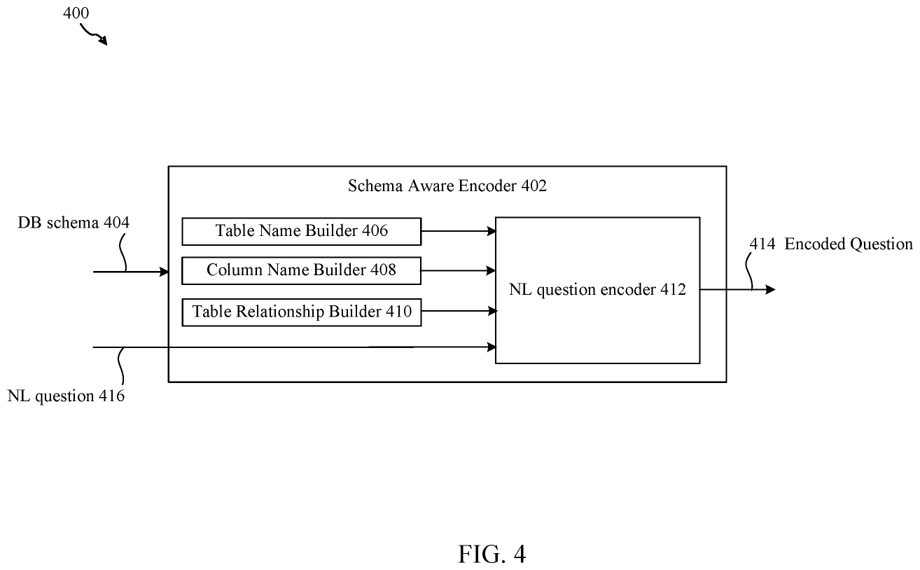

FIG. 4 illustrates an example 400 of a schema aware encoder 402, according to an embodiment. Schema aware encoder 402 may be an example of schema aware encoder 310 in Test2SQL code generator 306 of FIG. 3. Schema aware encoder 402 may receive as input DB schema 404 and NL question 416. Schema aware encoder 402 may generate as output encoded question 414. Schema aware encoder 402 may include, for example, table name builder 406, column name builder 408, table relationship builder 410 and NL question encoder 412.

Table name builder 406, column name builder 408, and table relationship builder 410 may process DB schema information 404 to generate information that NL question encoder 412 may use to convert NL question 416 into a schema-aware NL question referred to as encoded question 414. For example, table name builder 406 may extract table names from DB schema information 404. Column name builder 408 may extract from DB schema 404 column names within tables indicated by DB schema information 404. Table relationship builder 410 may extract from DB schema 404 table relationship information for tables indicated by DB schema information 404. Table name builder 406, column name builder 408, and table relationship builder 410 are presented as examples of the type of DB schema information that may be extracted to improve the performance of a text2SQL generator. Various examples may extract the same or different types of information from a DB schema to encode an NL question and/or otherwise generate a database query. Similarly, other types of NL processors may extract a variety of schema information.

NL question encoder 412 may receive (e.g., or have access to) NL question 416, as well as table names, column names, and table relationships in one or more databases pertinent to NL question 416. NL question encoder 412 may (e.g., first) process (e.g., parse) NL question 416, for example, to determine which database(s) are pertinent to NL question 416. NL question encoder 412 may determine which database, which location, and/or which information from which of multiple clients/customers/tenants using a cloud storage service may be accessed based on information in NL question 416. NL question encoder 412 may (e.g., then) access table names, column names, and table relationships pertaining to the information stored in one or more databases determined based on information provided in or associated with the context of NL question 416.

NL question encoder 412 may, for example, generate encoded question 414 with the following format:
“<T>{list of table names}|<C>{list of column names}|<S>{list of foreign key relationships}|<Q>{natural language description} [SEPARATOR][“SQL:”]
The grammar shown in the example depicts the following parts of the encoding: table names (e.g., indicated by <T>{list of the table names}), column names (e.g., indicated by <C>{list of column names}), a list of foreign key relationships (e.g., indicated by <S>{list of foreign key relationships}), a natural language description (e.g., indicated by <Q>{natural language description}), an indication of the end of the NL question (e.g., indicated by [SEPARATOR]), and an indication of the task (e.g., indicated by [“SQL:”]).

The list of database table names may comprise, for example, a comma separated list of the existing table names in the targeted database(s). The list of database table names may include a full set or a subset of existing tables.

The list of table column names may comprise, for example, a comma separated list of the existing column names in the targeted database, which may be written, for example, in a table_name.column_name notation. The list of table column names may (e.g., for each table presented in the list of database table names) include a full set or a subset of existing columns. The list of table column names may include an asterisk symbol (*), for example, to describe the usage of all table columns.

The list of table foreign key relationships may comprise, for example, a comma separated list of foreign key relationships, which may be written, for example, in the form table_name1.primary_key=table_name2.foreign key. The list of table foreign key relationships may include, for example, a full set or a subset of existing foreign key relationships.

The natural language description may comprise, for example, a natural language description (e.g., or the NL question) of the desired query. The NL description may include, for example, all or a portion of NL question 416.

The indication of the end of the NL question may comprise, for example, a separator (e.g., space(s) and/or character(s)), which may be used to indicate to the model when the prompt is completed, and the generation of the query should begin.

The indication of the task for the model to complete may comprise, for example, a task description to state to the model that it should generate the code written in SQL language.

Portions of the example encoding are shown inside the brackets ([ ]), showing optional encoding that may be used to exploit a meta-learning ability of big language models. For example, the separator and task may be helpful for an encoding used in combination with a big language model, such as GPT-3.

With reference to the example of a database table structure shown in FIG. 2 for an NL question, “What is the total number of singers?,” NL question encoder 412 may, for example, generate encoded question 414 with the following format for an autoregressive GPT-3 model, including sequence ‘##’ as a separator:
<T>stadium, singer, concert|<C>*, stadium.stadium_id, stadium.name, singer.singer_id, singer.full_name, concert.concert_id, concert.stadium_id, concert.singer_id|<S>concert.stadium_id=stadium.stadium_id, concert.singer_id=singer.singer_id|<Q>What is the total number of singers?##SQL:

This example encoding may provide several advantages. For example, the encoding is simple and human readable without unnecessary complexity and without additional processing steps of constraint decoding and SQL completion.

The encoding encodes information regarding the existing foreign key relationships in the database. This may improve model performance compared to providing information about the pairs of joinable tables and requiring inference about corresponding primary and foreign keys, which may be ambiguous, e.g., if a table has multiple foreign key relationships.

The encoding is optimized to be used with big language auto-regressive machine learning models. A characteristic of auto-regressive models is that the order of tokens in the input may be important. Auto-regressive models may tend to forget (e.g., minimize the importance of) tokens close to the beginning of the input. This may occur, for example, if the input length of an NL question is large. Big language models exhibit substantial meta-learning ability. The importance of inputs may be stressed, for example, by ordering input encoding components (e.g., with table descriptions prior to column descriptions and the question or NL description last). A meta-learning ability may be exploited, for example, by providing a task description (e.g., “SQL:” portion of encoding grammar), e.g., with a separator.

The encoding may be used, for example, NL text interpretation and/or conversion tasks (e.g., text-to-SQL tasks). Performance improvement (e.g., NL question to SQL query execution accuracy) may be realized, for example, by using the encoding with a Codex-Cushman model and a Spider dataset. Improvement in performance metrics may include, for example, accuracy, reduction in the number of uncompilable queries, e.g., at the same level of output parsing, reduction in complexity (e.g., elimination of a complex constraint decoder in big language models). Embodiments and testing described herein show that proper encoding of database schema and natural language description in the input may (e.g., significantly) improve performance of NL text interpretation and/or conversion tasks (e.g., text-to-SQL tasks).

Schema aware encoding may improve performance over a wide range of natural language, ranging from simple/easy to extremely complex/difficult categories. The performance improvement may increase with NL query complexity. The incorporation of database schema relationship information in the input may significantly improve a model's reasoning of the database context.

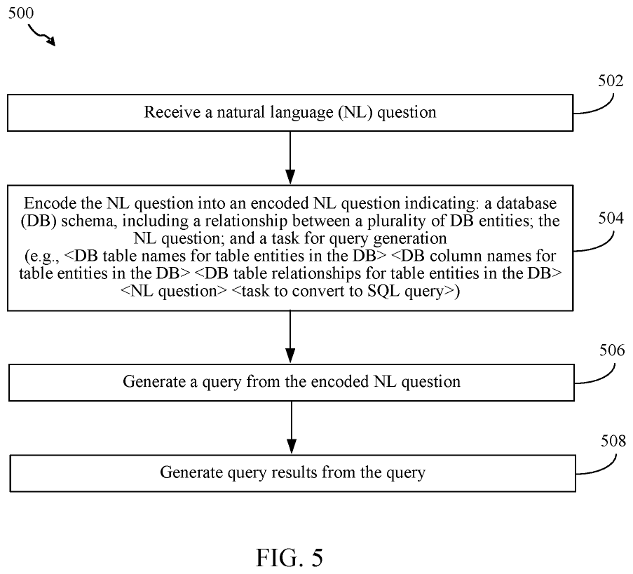

FIG. 5 illustrates a flowchart of an example method 500 for performing schema-aware encoding of natural language, according to an example embodiment. Embodiments disclosed herein and other embodiments may operate in accordance with example method 500. Method 500 comprises steps 502, 504, 506 and 508. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 5. In various implementations, steps may be added, removed, implemented in the alternative, e.g., in any combination or order. FIG. 5 is simply one of many possible embodiments. Embodiments may implement fewer, more or different steps.

As shown in FIG. 5, in step 502, an NL question may be received. For example, as shown in FIG. 1, NL server(s) 102 may receive NL question 108 from client computing device(s) 116.

As shown in FIG. 5, in step 504, the NL question may be encoded into an encoded NL question indicating: a database (DB) schema, including a relationship between a plurality of DB entities; the NL question; and a task for query generation. For example, as shown in FIG. 1, schema aware input encoder 104 in NL server(s) 102 may encode NL question 108 into encoded question 106, which may include a DB schema indicating a relationship between a plurality of tables 134; NL question 108; and the task of converting encoded question 106 into query 126. As shown by example in FIG. 5, encoded question 106 may include the following information (e.g., in the following order): <DB table names for table entities in the DB><DB column names for table entities in the DB><DB table relationships for table entities in the DB><NL question><task to convert to SQL query>).

As shown in FIG. 5, in step 506, a query may be generated from the encoded NL question. For example, as shown in FIG. 1, DB query generator 122 in query server(s) 120 may generate query 126 based on encoded question 106.

As shown in FIG. 5, in step 508, query results may be generated from the query. For example, as shown in FIG. 1, database server(s) 130 may generate query results 128 by executing query 126 against DB tables 134.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of one or more of client computing device 116, NL server(s) 102, query server(s) 120 or database server(s) 130 of FIG. 1, which may include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows

Computing device 602 can be any of a variety of types of computing devices. For example, computing device 602 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing one or more of NL interface 118, schema aware input encoder 104, DB query generator 122, SQL manager 308, client 318, text2SQL code generator 308, schema aware encoder 402, etc., along with any components and/or subcomponents thereof, as well as the flowcharts/flow diagrams (e.g., method 500) described herein, including portions thereof, and/or further examples described herein.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi 662 modem (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform such as Amazon Web Services® of Amazon Web Services, Inc. or Google Cloud Platform™ of Google LLC, although these are only examples and are not intended to be limiting.

In an embodiment, computing device 602 may access application programs 676 for execution in any manner, such as by a client application and/or a browser at computing device 602. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### IV. Further Example Embodiments

Methods, systems and computer program products are provided for performing schema-aware encoding of natural language. A natural language (NL) question may be encoded into a schema-aware encoded question, for example, to improve a query (e.g., structured query language (SQL) query) generated by a database query generator (e.g., an SQL code generator model) based on the question. An improved query may improve the accuracy of results generated by a database server (e.g., SQL database server) based on query execution, which may reduce resource consumption and improve customer satisfaction, e.g., by avoiding repetitious searches for desired results. An encoded NL question may include, for example, the NL question and/or an indication of the task (e.g., to convert the encoded NL question into an SQL query). An encoded, and a schema. A schema may include, for example, one or more full or partial lists of DB tables names, DB column names, and interrelationships between DB entities (e.g., tables), such as primary key-foreign key relationships between tables. NL encoding may be optimized for a type of NL processing model, e.g., an autoregressive language model used to generate a SQL query. An NL question may be encoded with a relative ordering of schema (e.g., table names, column names, foreign key relationships), the NL question, and/or the task.

In examples, a system may comprise an encoder implemented by one or more computing devices that receives (e.g., intercepts) a natural language (NL) question; and encodes the NL question into an encoded NL question indicating a database (DB) schema for a DB, including a relationship between a plurality of DB entities (e.g., tables in the DB); and the NL question.

In examples, the encoder may encode the NL question into the encoded NL question, further indicating: a task for a query generator.

In examples, the task may comprise an indication for the query generator to generate a structured query language (SQL) query based on the encoded NL question.

In examples, the system may (e.g., further) comprise the query generator that is implemented by the one or more computing devices and that generates a query based on the encoded NL question.

In examples, the system may (e.g., further) comprise a query processor that is implemented by the one or more computing devices and that executes the query against the DB.

In examples, the query generator may comprise an autoregressive language model.

In examples, the DB schema may comprise a full set or a subset of a list of: table names for table entities in the DB; column names for the table entities in the DB; and foreign key relationships for the table entities in the DB.

In examples, the encoder may be (e.g., further) configured to: generate the encoded NL question with a relative ordering of the table names, column names, foreign key relationships, and the NL question.

In examples, a computer-implemented method may comprise receiving a natural language (NL) question; encoding the NL question into an encoded NL question indicating: a database (DB) schema for a DB, including at least one interrelationship between a plurality of entities (e.g., tables) in the DB; the NL question; and a task for a query generator.

In examples, the task may comprise an indication for the query generator to generate a structured query language (SQL) query based on the encoded NL question.

In examples, the method may (e.g., further) comprise generating a query based on the encoded NL question.

In examples, the method may (e.g., further) comprise executing the query against the DB; and generating query results.

In examples, the query generator may comprise an autoregressive language model.

In examples, the DB schema may comprise a full set or a subset of a list of: table names for table entities in the DB; column names for the table entities in the DB; and foreign key relationships for the table entities in the DB.

In examples, the method may (e.g., further) comprise generating the encoded NL question with a relative ordering of the table names, column names, foreign key relationships, and the NL question.

In examples, a computer-readable storage medium may have program instructions recorded thereon that, when executed by a processing circuit, perform a method. The method may comprise receiving [intercepting] a natural language (NL) question; and encoding the NL question into an encoded NL question indicating: a database (DB) schema for a DB, including at least one interrelationship between a plurality of tables in the DB; and the NL question.

In examples, the method may (e.g., further) comprise at least one of the following: wherein the encoded NL question comprises an indication to generate a structured query language (SQL) query based on the encoded NL question; or generating the SQL query based on the encoded NL question.

In examples, the method may (e.g., further) comprise executing the query against the DB; and generating query results.

In examples, the DB schema may comprise a full set or a subset of a list of: table names for the tables in the DB; column names for the tables in the DB; and foreign key relationships for the tables in the DB.

In examples, the method may (e.g., further) comprise generating the encoded NL question with a relative ordering of the table names, column names, foreign key relationships, and the NL question.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A system, comprising:
a computing device; and
an encoder implemented by the computing device that:
receives a natural language (NL) question; and
encodes the NL question into an encoded NL question indicating:
a database (DB) schema for a DB, including a relationship between a plurality of DB entities in the DB;
the NL question; and
a conversion task for a query generator.

2. (canceled)

3. The system of claim 1, wherein the conversion task comprises an indication for the query generator to generate a structured query language (SQL) query based on the encoded NL question.

4. The system of claim 1, further comprising:
the query generator that is implemented by the computing device and that generates a query based on the encoded NL question.

5. The system of claim 4, further comprising:
a query processor that is implemented by the computing device and that executes the query against the DB.

6. The system of claim 1, wherein the query generator comprises an autoregressive language model.

7. The system of claim 1, wherein the DB schema comprises a full set or a subset of a list of:
table names for table entities in the DB;
column names for the table entities in the DB; and
foreign key relationships for the table entities in the DB.

8. The system of claim 7, wherein the encoder is further configured to:
generate the encoded NL question with a relative ordering of the table names, column names, foreign key relationships, and the NL question.

9. A computer-implemented method comprising:
receiving a natural language (NL) question; and
encoding the NL question into an encoded NL question indicating:
a database (DB) schema for a DB, including at least one interrelationship between a plurality of entities in the DB;
the NL question;
a task for a query generator; and
a conversion task for a query generator.

10. The computer-implemented method of claim 9, wherein the conversion task comprises an indication for the query generator to generate a structured query language (SQL) query based on the encoded NL question.

11. The computer-implemented method of claim 9, further comprising:
generating a query based on the encoded NL question.

12. The computer-implemented method of claim 11, further comprising:
executing the query against the DB; and
generating query results.

13. The computer-implemented method of claim 9, wherein the query generator comprises an autoregressive language model.

14. The computer-implemented method of claim 9, wherein the DB schema comprises a full set or a subset of a list of:
table names for table entities in the DB;
column names for the table entities in the DB; and
foreign key relationships for the table entities in the DB.

15. The computer-implemented method of claim 14, further comprising:
generating the encoded NL question with a relative ordering of the table names, column names, foreign key relationships, and the NL question.

16. A computer-readable storage medium having program instructions recorded thereon that, when executed by a processing circuit, perform a method comprising:
receiving a natural language (NL) question; and
encoding the NL question into an encoded NL question indicating:
a database (DB) schema for a DB, including at least one interrelationship between a plurality of tables in the DB;
the NL question; and
a conversion task for a query generator.

17. The computer-readable storage medium of claim 16, the method further comprising at least one of the following:
wherein the conversion task included in the encoded NL question comprises an indication to generate a structured query language (SQL) query based on the encoded NL question.

18. The computer-readable storage medium of claim 17, the method further comprising:
executing the query against the DB; and
generating query results.

19. The computer-readable storage medium of claim 16, wherein the DB schema comprises a full set or a subset of a list of:
table names for the tables in the DB;
column names for the tables in the DB; and
foreign key relationships for the tables in the DB.

20. The computer-readable storage medium of claim 19, the method further comprising:
generating the encoded NL question with a relative ordering of the table names, column names, foreign key relationships, and the NL question.

21. The computer-readable storage medium of claim 16, the method further comprising:
generating the SQL query based on the encoded NL question.
